(19) United States
(12) Patent Application Publication
(10) Pub. No.: US 2022/0116390 A1
(43) Pub. Date: Apr. 14, 2022

(54) SECURE TWO-WAY AUTHENTICATION USING ENCODED MOBILE IMAGE

(71) Applicant: VIVIAL MOBILE LLC, Dayton, OH (US)

(72) Inventors: Nicole Jass, Aurora, CO (US); Matthew Brown, Colorado Springs, CO (US)

(21) Appl. No.: 17/559,018

(22) Filed: Dec. 22, 2021

Related U.S. Application Data
(63) Continuation-in-part of application No. 16/856,879, filed on Apr. 23, 2020, now Pat. No. 11,245,695.
Application No. 16/856,879 is a continuation of application No. 15/785,672, filed on Oct. 17, 2017, now Pat. No. 10,673,849.
Application No. 15/785,672 is a continuation of application No. 14/882,321, filed on Oct. 13, 2015, now Pat. No. 9,825,947.
(60) Provisional application No. 62/063,245, filed on Oct. 13, 2014.

(51) Int. Cl. H04L 67/02; H04L 67/306; H04W 4/00; H04W 12/06; G06F 21/44

(52) U.S. Cl. CPC H04L 63/0869; H04L 67/02; G06F 21/445; H04W 4/00; H04W 12/06; H04L 67/306

(57) ABSTRACT

A method of digital authentication and related devices are disclosed. The method includes providing an authenticator for use with a first computing device; displaying a login screen on the first computing device, wherein the login screen is associated with an application; receiving a first set of factors at the first computing device; sending information related to the first set of factors to a processing system; receiving a second set of factors from one of the first computing device or a second computing device; and using information related to one or more of the first set of factors and the second set of factors to: authenticate the application on the first computing device, authenticate a user on the login screen displayed on the first computing device, or a combination thereof.

### PRIORITY

This application is a continuation in part of U.S. application Ser. No. 16/856,879, filed Apr. 23, 2020 and entitled “Secure Two-Way Authentication Using Encoded Mobile Image”, which is a continuation of U.S. patent application Ser. No. 15/785,672, filed Oct. 17, 2017 and entitled “Secure Two-Way Authentication Using Encoded Mobile Image”, issued as U.S. Pat. No. 10,673,849 on Jun. 2, 2020; which is a continuation of U.S. patent application Ser. No. 14/882,321, filed Oct. 13, 2015, U.S. Pat. No. 9,825,947, issued Nov. 21, 2017, and entitled “Secure Two-Way Authentication Using Encoded Mobile Image,” which claims priority to U.S. Provisional Application No. 62/063,245, filed Oct. 13, 2014 and entitled “Secure Two-Way Authentication Using Encoded Mobile Image,” all of which are incorporated herein by reference in their entireties.

### FIELD OF THE INVENTION

This invention is related to digital authentication of users and websites.

### BACKGROUND OF THE INVENTION

On-line user authentication is increasingly critical for software-as-a-service (SAAS) providers, as well as for any digital product/service that needs to determine user authenticity. When a user accesses a website or any on-line service, either by entering a website address in a browser, through a search, by clicking on a link, or through any other scenario, the user may seek to authenticate the website or on-line service to ensure that it is a legitimate website/service that is actually provided by the entity the user is seeking to interact with. Frequently, users require assurances that accessed websites and on-line services do not have any known or unknown malicious intent upon accessing the website or service. For example, prior to accessing specific features in a website or offered through a service, users often require confirmation that the website/service will not install a virus on the device through which they are accessing the website/service, and/or will not steal their personal information. Similarly, website owners and SAAS providers have a need to securely authenticate users that access the owners' website/service, in order to ensure that the user is accessing and managing proper account information, as well as to enable user-specific website/service features such as, but not limited to, user-specific transaction features.

### SUMMARY OF THE INVENTION

An exemplary method of digital authentication includes providing a scanning application on a computing device prior to scanning one or more website features, and scanning the one or more website features, the one or more website features having been displayed on a web page of another computing device. The exemplary method includes sending information related to the one or more scanned website features to a processing system, and using the information related to the one or more scanned website features to authenticate the web page on the another computing device, and enable one or more web page components of the web page. The one or more web page components include at least one of (a) automatically setting up a new account on the web page with user profile information, (b) completing a purchase on the web page, or (c) automatically logging the user into the website.

An exemplary non-transitory, tangible, computer-readable storage medium for a computing device is encoded with processor-readable instructions which, together, include a scanning application to perform a method of authenticating a device. The method includes scanning one or more website features, the one or more website features having been displayed on a web page of another computing device. The method includes ending information related to the one or more scanned website features to a processing system. The method includes using the information related to the one or more scanned website features to authenticate the web page on the other computing device, and enable one or more web page components of the web page. The one or more web page components include at least one of (a) automatically setting up a new account on the web page with user profile information, (b) completing a purchase on the web page, and (c) automatically logging the user into the website.

An exemplary method of providing digital authentication includes accessing a website from a mobile computing device, wherein the website includes at least one website feature. The method includes displaying the at least one website feature on the mobile computing device, selecting the at least one website feature, launching a scanning application on the mobile computing device, displaying first new information on the website, and displaying second new information in the scanning application. The method includes selecting a scanning application feature when the first new information is the same as the second new information, authenticating the website, accessing one or more website features, and enabling web page components. The web page components include at least one of (a) automatically setting up a new account on the web page with user profile information, (b) completing a purchase on the web page, and (c) automatically logging the user into the website.

Another method of digital authentication comprises providing an authenticator for use with a first computing device; displaying a login screen on the first computing device, wherein the login screen is associated with an application; receiving a first set of factors at the first computing device; sending information related to the first set of factors to a processing system; receiving a second set of factors from one of the first computing device or a second computing device; and using information related to one or more of the first set of factors and the second set of factors to authenticate the application on the first computing device, authenticate a user on the login screen displayed on the first computing device, wherein authenticating the user comprises enabling one or more components of the application, the one or more components comprising at least one of (a) linking a user account associated with the user to the second set of factors, (b) completing a purchase on the application, or (c) automatically logging the user into the application, or a combination thereof.

Some embodiments of the present disclosure also relate to a plurality of non-transitory, tangible, computer-readable storage medium across a plurality of devices, wherein the plurality of non-transitory, tangible, computer-readable storage medium are encoded with processor-readable instructions which, together, perform a method of digital authentication, the method comprising: providing an authenticator for use with a first computing device; displaying a login screen on the first computing device, wherein the login screen is associated with an application; receiving a first set of factors at the first computing device; sending information related to the first set of factors to a processing system; receiving a second set of factors from one of the first computing device or a second computing device; and using information related to one or more of the first set of factors and the second set of factors to authenticate the application on the first computing device, authenticate a user on the login screen displayed on the first computing device, wherein authenticating the user comprises enabling one or more components of the application, the one or more components comprising at least one of (a) linking a user account associated with the user to the second set of factors, (b) completing a purchase on the application, or (c) automatically logging the user into the application, or a combination thereof.

Other embodiments of the disclosure may be characterized as a system configured for digital authentication, the system comprising one or more hardware processors configured by machine-readable instructions to: provide an authenticator for use with a first computing device; display a login screen on the first computing device, wherein the login screen is associated with an application; receive a first set of factors at the first computing device; send information related to the first set of factors to a processing system; receive a second set of factors from one of the first computing device or a second computing device; and use information related to one or more of the first set of factors and the second set of factors to: authenticate the application on the first computing device, authenticate a user on the login screen displayed on the first computing device, wherein authenticating the user comprises enabling one or more components of the application, the one or more components comprising at least one of (a) linking a user account associated with the user to the second set of factors, (b) completing a purchase on the application, or (c) automatically logging the user into the application, or a combination thereof.

In some examples of the method, the non-transitory, tangible, computer-readable storage medium(s), and the system, the first set of factors comprise one of knowledge factors, inherence factors, and possession factors.

In some examples of the method, the non-transitory, tangible, computer-readable storage medium(s), and the system, the second set of factors comprise another one of knowledge factors, inherence factors, and possession factors, wherein the first set of factors are different from the second set of factors.

In some examples of the method, the non-transitory, tangible, computer-readable storage medium(s), and the system, the knowledge factors are selected from a group consisting of user credential information, a PIN, a passcode, an answer to a security question, and a one-time password; the inherence factors comprise biometric information, the biometric information selected from a group consisting of a fingerprint scan, voice scan, retina scan, iris scan, and behavioral analysis information for the user; and the possession factors are selected from a group consisting of a physical keycard, USB dongle, a Near Field Communication (NFC) dongle, a mobile device, an access badge, a one-time password (OTP), a private key, and a software token or certificate.

In some examples of the method, the non-transitory, tangible, computer-readable storage medium(s), and the system, authenticating the application on the first computing device comprises: providing a domain associated with the application to the authenticator on the first computing device; accessing, by the authenticator, the first set of factors from the first computing device; receiving, by the authenticator, a challenge from the processing system; and signing, by the authenticator, the challenge, wherein the signing is based at least in part on the domain associated with the application and the first set of factors.

In some examples of the method, the non-transitory, tangible, computer-readable storage medium(s), and the system, the signing is further based in part on a public-private key pair associated with the user account, the public-private key pair including a private key stored by the authenticator and a public key stored by the processing system, and wherein automatically logging the user into the application comprises: receiving, by the processing system, the signed challenge from the authenticator; determining, by the processing system, possession of the private key by the authenticator based in part on the received signed challenge; and verifying the user based in part on determining that the authenticator possesses the private key corresponding to the public-private key pair.

Some examples of the method, system, and non-transitory computer-readable medium described above may further include processes, features, means, or instructions for receiving, by the authenticator, a third set of factors, wherein the third set of factors comprise one of biometrics information or user credential information for the user, the user credential information comprising one or more of a username, a password, a PIN, and a passcode. In some examples of the method, the non-transitory, tangible, computer-readable storage medium(s), and the system, the second set of factors comprise at least one of the public key or the private key. In some examples of the method, the non-transitory, tangible, computer-readable storage medium(s), and the system, the second set of factors are unlocked based in part on receiving the third set of factors.

In some examples of the method, the non-transitory, tangible, computer-readable storage medium(s), and the system, the authenticator is one of a biometrics authenticator, a hardware authenticator, or a software authenticator.

Some examples of the method, system, and non-transitory computer-readable medium described above may further include processes, features, means, or instructions for storing, by the authenticator, the first set of factors and the second set of factors, wherein the storing comprises linking the first set of factors and the second set of factors to the user account for the application.

In some examples of the method, the non-transitory, tangible, computer-readable storage medium(s), and the system, the first set of factors comprise a time factor or a location factor.

Some examples of the method, system, and non-transitory computer-readable medium described above may further include processes, features, means, or instructions for determining a risk level based on assessing the first set of factors; receiving a third set of factors from one of the first computing device and the second computing device based on determining the risk level exceeds a threshold; and using information related to the first, second, and third set of factors to authenticate the application on the first computing device, authenticate the user on the login screen displayed on the first computing device, or a combination thereof.

In some examples of the method, the non-transitory, tangible, computer-readable storage medium(s), and the system, the second set of factors are received from the second computing device.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 depicts a representation of a first computing device, third party system, and host server according to one embodiment of the invention;

FIG. 2 depicts a representation of a first computing device, second computing device, and third party system according to one embodiment of the invention;

FIG. 3 depicts a representation of a first computing device, second computing device, and host server according to one embodiment of the invention;

FIG. 4 depicts a representation of a first computing device and second computing device according to one embodiment of the invention;

FIG. 5A depicts a prior art login screen;

FIG. 5B depicts a representation of a first computing device, second computing device, and third party system according to one embodiment of the invention;

FIG. 5C depicts a representation of a first computing device, second computing device, and third party system according to one embodiment of the invention;

FIG. 6 depicts a diagrammatic representation of one embodiment of a computer system according to one embodiment of the invention;

FIG. 7 depicts a method according to one embodiment of the invention;

FIG. 8 depicts a method according to one embodiment of the invention;

FIG. 9 depicts a process flow for multifactor authentication (MFA), according to various aspects of the disclosure;

FIG. 10 depicts another process flow for MFA, according to various embodiments of the disclosure; and

FIG. 11 depicts a computing device configured for MFA, according to various aspects of the disclosure.

### DETAILED DESCRIPTION

One authentication process described herein can include various features to ensure the website is actually being provided by the entity displayed thereon. These features can include but are not limited to an item the user possesses such as a mobile phone, chip, ID card, or key fob; something the user knows such as a password, or pin; or something the user comprises such as a biometric signature like a fingerprint, heartbeat, or retina image. In order to properly authenticate websites for users, and users for websites, a technology has been developed to enable secure two-way authentication between users and websites using a mobile phone, a mobile barcode, and a matching item such as, but not limited to, an image. Through the use of this system, consumers may interact with websites using their mobile phone, allowing for quick website authentication that does not require a customer to answer challenge questions when they sign into the website on new device. The system also adds an additional security feature for users of requiring a mobile phone to authenticate with a website. Similarly, additional security is provided to website owners by requiring a mobile device for user sign-in and also provides customers with a simple way to sign-in. Additional features can be added to the user authentication including items that the user knows such as, but not limited to, passwords or pins, and/or can also include a biometric confirmation such as, but not limited to a fingerprint or heartbeat scan. Furthermore, application downloads may be increased by creating an integrated website and mobile computing device application.

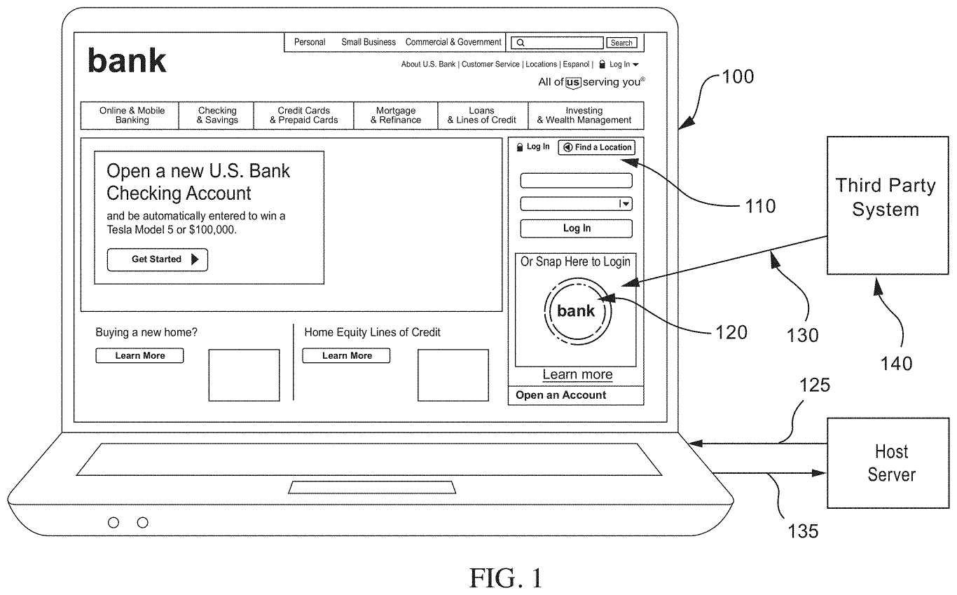

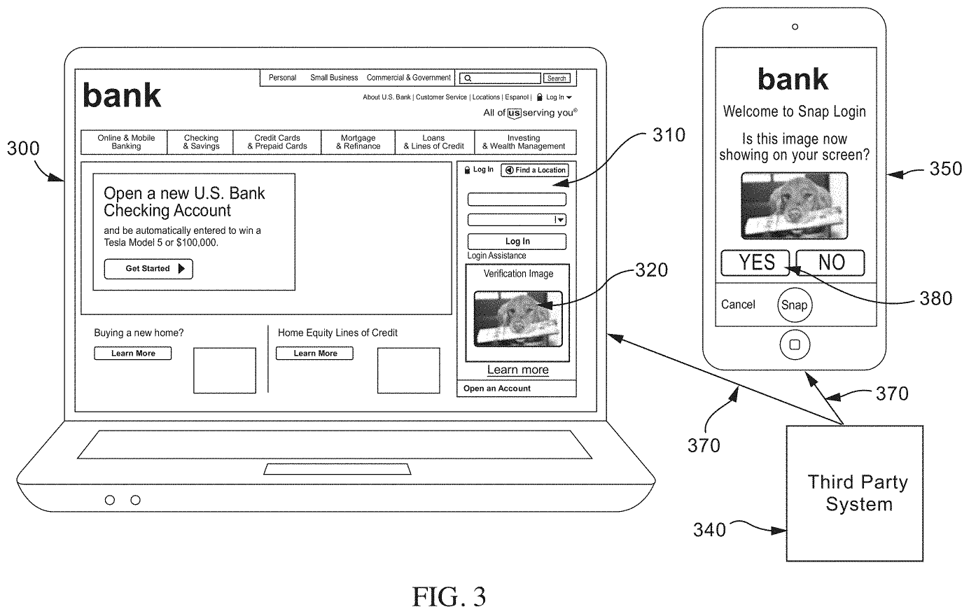

Turning first to FIG. 1, seen is a first computing device 100. In one embodiment, the first computing device 100 displays a website 110 (also referred to herein as a web page 110 or a service or SAAS) comprising a website feature 120. However, it is contemplated that the website feature 120 may be incorporated into other operations on the first computing device 100 besides a website 110 such as, but not limited to an application. In any event, the website feature 120 may comprise a display having an encoded value associated with the display. One such display may be seen in FIG. 3, in which the website feature 320 displays an image. The website feature 120 may comprise a plug-in website feature 120 or an embedded website feature 120. One plug-in website feature 120 may comprise a separate software component that adds a specific feature to the already existing website 110, whereas the embedded web site feature 120 may comprise a portion of the website code itself. The value associated with the display in the plug-in website feature 120 or embedded website feature 120 may also be referred to herein as a “mobile barcode.” One mobile barcode may be dynamically generated and fed 130 to the website feature 120 via a third-party platform 140. For example, upon requesting 125 a host server 115 (with the host server 115 comprising the website 110 information to display on the device 100, with the information/mobile barcode being provided to the device 100 in a response 135 to the request 125) of the website 110 or on-line service provide the website 110 or service to the device 110, a display session for the web page 110 may be created by the server 115. Each website display session may be associated with a unique mobile barcode. One such mobile barcode may comprise a SNAPTAG® provided by SpyderLynk LLC, a Colorado Limited Liability Company whose principal place of business is 9559 S. Kingston Ct. Suite 200, Englewood, Colo. 80112.

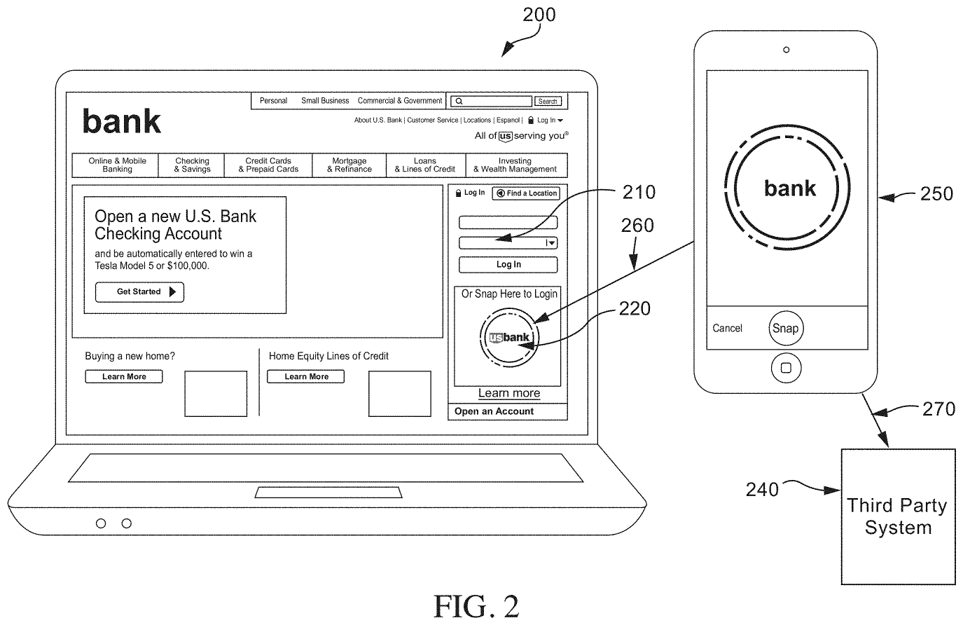

Turning now to FIG. 2, seen is the first computing device 200 and a second computing device 250. The first computing device 200 may comprise a laptop computer, desktop computer, tablet computing device, or any other computing device comprising a display. The second computing device 250 may comprise a mobile computing device or may comprise any other computing device with a camera or any other scanning device. In one such embodiment, upon accessing the website 210 with the first computing device 200, a user may be informed that the website feature 220 must be scanned with the second computing device 250. For example, a pop-up window may be displayed which informs the user that the mobile barcode in the website feature 220 may be scanned with an application on the second computing device 250. Such an application may be an application provided by an owner of the website 210 or may be an application provided by the third-party 240. Such an application may be branded similarly as the website 210. The pop-up display may enable the user to send a link or other information to the second mobile computing device 250 which enables the second mobile computing device 250 to download the application on the device 250 and subsequently scan the website feature 220 displayed on the web page 210.

Prior to an initial use of the application on the second computing device 250, a user of the device 250 may be prompted to provide user profile information on the second computing device 250 which will be associated with the application. For example, the application may prompt the user to provide the user's name, email address, and login information (e.g., username/password) for the website 210 and/or any other websites the user may use the application to securely access. Upon entering the prompted information into the application, the user uses the application to scan 260 the mobile barcode. A scan 260 of the mobile barcode may comprise using a camera associated with the second mobile computing device 250 with take one or more pictures of the mobile barcode/website feature 220. Upon scanning 260 the mobile barcode, the application may send 270 the mobile barcode image and/or information related to the mobile barcode image, along with any login information (e.g. username/password) associated with the website 210 to a third party system 240, also referred to herein as a processing system 240 or processing device 240. Alternatively, or additionally to the website-specific login information and/or the information associated with the scan (e.g., image, location/placement of one or more features in the scan), a website/app token may also be sent 270 to the third-party system 240. Upon receiving the mobile barcode and token/login information the third-party system 240 may authenticate the user using information associated with or encoded within the mobile barcode, accessing a database on the third-party system 240 comprising information related to one or more previously-saved tokens, mobile barcodes and/or user login information. For example, only e-mail information may be stored in the database.

Turning now to FIG. 3, seen is an example of one type of authentication that may be implemented by the third-party system 340 to authenticate the user with the website 310 on the first computing device 300 through the use of the second mobile computing device 350. For example, the third-party system 340 may send 370 information for engagement on the first computing device and the second computing device. The information for engagement may include an image sent to the website feature 320 for display on the website 310 and to the application for display on the second computing device 350. This image may be an image that is randomly-selected by the third-party 340 or may be an image previously selected by the user, such as, but not limited to, during the installation/set-up of the app on the second device 250. Such an image may display any type of picture (e.g., a house, animal, sporting equipment, mountains, etc.) for this authentication step. Upon receiving the image(s) at the devices 300, 350, the same image is displayed on each device 300, 350. At this point, the user may be prompted on each device 300, 350, or just one of the devices, to confirm whether the same image is displayed on each device 300, 350. If so, the user may click a button 380 on the second computing device 350, or may otherwise verify that the same image is displayed.

Upon verifying the images are the same, the second mobile computing device 350 may send a communication to the third-party system 340 confirming the images are the same. The user may enter a pin on the device 350 or other information such as, but not limited to, biometric information, may be entered and/or provided by the application on the second mobile computing device 350 and provided in this communication to the third party system 340 for additional security. One or more third-party systems 340 may be used to process this pin and/or other information. For example, a first third-party system 340 may provide process a communication received from the second computing device 350 and a communication with a second third-party system 340 may be implemented so the second third-party system 340 handles the biometric or other information processing. The third-party systems 340 may then send one or more communications 370 to the website 310 and/or application (which may comprise information related to the rendering of the website 310 at the first computing device 300 and/or one more third computing devices (not shown)), enabling the user to access various website features associated with the session ID, token and/or login information presented (which may include the additional authentication features described above such as, but not limited to, a password, PIN and/or biometric confirmation). In one embodiment, the website 310 may then send a confirmation message back to the third party 340 to verify that the session ID and user information are approved for authentication. The third party system 340 and/or the first mobile computing device 300 may send a communication to the second mobile computing device 350 to inform the second mobile computing device 350 that the user has been approved for authentication.

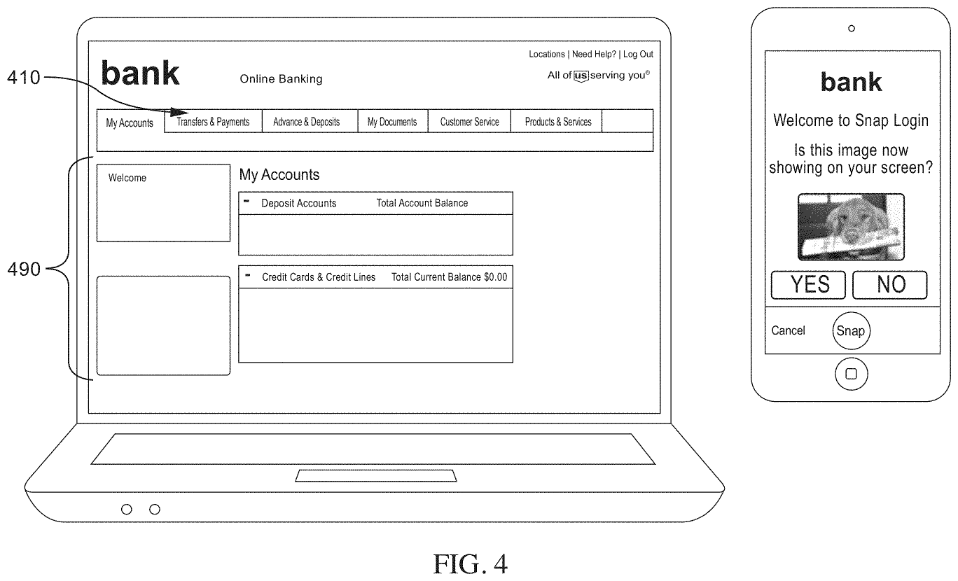

Seen in FIG. 4 is one view of web site features 490 that may be displayed to the user upon authentication approval. For example, displayed is a “my accounts” feature, although other features such as, but not limited to, transaction features, are contemplated. Furthermore, a positive authentication notification message may be displayed on the website 410 to let a user know that the website has been fully authenticated and that the user is safe to access the website features.

It is further contemplated that a user may not want to provide any information (e.g. username/password) to the website 100 or third party system 340 seen in FIGS. 1 and 3 and elsewhere, herein. For example, a user may only use the scanning feature in the application on the second mobile computing device 250 seen in FIG. 2 to authenticate the website 210 that the user wishes to access. In one such embodiment, the user may scan the mobile barcode in the website 210 with the second mobile computing device 250. Upon sending the scan to the third party system 240, the user would be presented with a random image within the website 210 as well as the screen on the second mobile computing device 250. The user would confirm (on the first and/or second mobile computing devices) that the same image is on both the second computing device 250 screen and the website 210. In such an embodiment, the third party 240 may then communicate with the website 210 and/or the user/second mobile computing device 250 to confirm with the website 210 has been authenticated. However, in such an embodiment, the third party 240 may not send any user info to the website 210, with the user using a preferences feature in the application setup process for determining when and how to share any information.

It is yet further contemplated that a user could scan the mobile barcode with the second mobile computing device 250, confirm the matching images as described above, and be automatically logged into the website 210 with information that has been previously stored on the third-party system 240. In such an embodiment, a user would essentially be logging into the website 210 without entering any information on the website 210. A user could be prompted to enter a PIN or a password on the second computing device 250, after image verification is complete, as an added layer of log-in security.

In the system seen and shown above with reference to FIGS. 1-4, a user may also scan the mobile barcode on the website 210 in order to setup a new account. For example, a user may confirm matching images on the website 210 and/or the second computing device 250 after conducting the scanning, as described above. At this point the user may click a “new account” button on the application, or a button comprising similar text. The third party system 240 may then send the user's information, which has already been entered by the user into the application on the second mobile computing device 250, to the website 210, with the website automatically setting up the new account in the website with this information.

It is contemplated that a user may also scan the mobile barcode in order to buy something using information stored in the mobile application and/or in the third party system 240. Furthermore, instead of, or in addition to, matching images to finalize the authentication process, a user may be asked to confirm that a sequence of letters and/or numbers or other symbols matches in the application and on the website 210. Alternatively, the user could be asked to confirm that a sound or video matches in the application and on the website 210. Also, instead of matching a randomly selected image, the image could have been pre-selected by the user or the image could be a logo or an image selected to be presented to the user from either the website owner and or an outside party. For example, the website 210 may present to the use an image provided/selected from the website. Or, the website 210 may provide an advertisement image to the user.

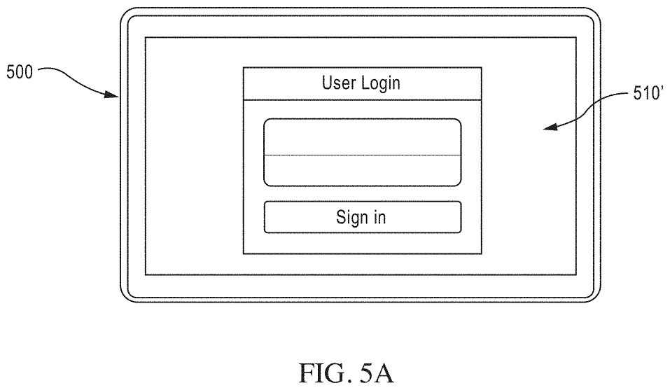

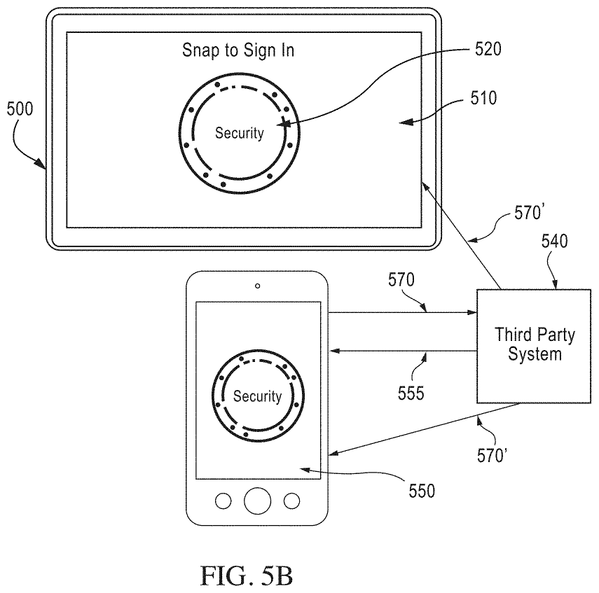

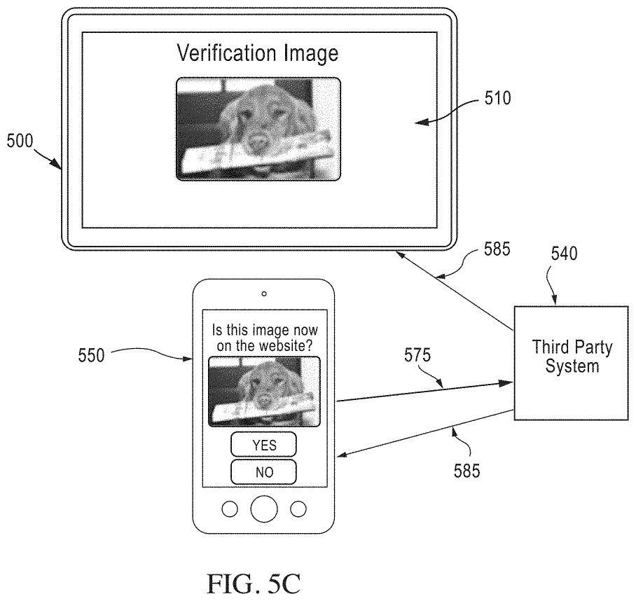

Looking now at FIG. 5A, seen is a prior art website 510′ requesting a username and password. In such a prior art website 510′, upon accessing the website 510′ with a first computing device 500, a user may sign-up to access the website 510 on the first computing device 500 by registering and subsequently entering a username/password on the first mobile computing device. However, this type of access requires using only a single device, the first mobile computing device 500, to access the website 510′.

In order to provide additional security to the prior art website 510′ seen in FIG. 5A, the website 510 seen in FIG. 5B was developed. In the FIG. 5B website 510, displayed is a single-use encoded image comprising a website feature 520. At this point, a user may be requested by the website 510 to download 555 and register an application, such as, but not limited, to a third-party application, on a second computing device 550 that may comprise a mobile computing device. The third-party application may be used to scan the website feature 520.

After scanning the website feature 520 with the downloaded 555 third-party application on the second computing device 550, the second computing device 550 may send 570 the scan to the third party 540. At this point, the third-party 540 may send 570′ the same image for display on both the second computing device 550 and the first computing device 500, as seen in FIG. 5C. The user then verifies 575 with the third-party system 540 that the same image is displayed on both the second computing device 550 and the first computing device 500. The website 510 then receives 585 a token from the third party system 540 enabling the user to access the website 510, while the second computing device 550 receives 585 a confirmation message for display on the second computing device 550. Alternatively, or additionally, an email, text, or other message may be sent to the user informing them that they have been signed in to the website 510.

Although not shown in the figures, above, it is contemplated that a similar authentication process would also work with only the second mobile computing device 250, 350, 550, described above. One such second mobile computing device 250, 350, 550 may comprise a mobile computing device. For example, the mobile computing device may access a website such as, but not limited to the website 210, 310, 510 seen above. Such a website 210, 310, 510 may comprise a mobile website. Upon accessing the mobile website, a display of the website feature 220, 320, 520 shown above may be seen. Such a website feature 220, 320, 520 may comprise a mobile website feature. When the mobile website feature is displayed, a user of the mobile computing device may tap or otherwise access the mobile website feature on the website. Such a tap may open up a pre-installed scanning application on the mobile computing device. Alternatively, if the pre-installed scanning application is not installed on the mobile computing device, tapping the mobile website feature may prompt the user of the mobile computing device to download the scanning application. Upon launching the scanning application, the user may be prompted to enter a pin number or a password into the scanning application, or to provide a biometric confirmation. Furthermore, the user may be presented with an image in the scanning application, and the image may be related to the mobile website (e.g., a logo for the company that owns the website, etc.). Such an image may enable the user to verify that the website is legitimate and owned by the proper entity. After the user provides the necessary information (pin/password/biometric, etc.) and has verified that the website is legitimate, a button may be clicked on the scanning application. Doing so may log the user into the mobile website as well as return the user to the website to access the desired information that is associated with the pin/password/biometric information. Alternatively, a user may not provide any pin/password/biometric information and only verify that the website is legitimate. At such a point, the user may be taken back to the website, secure with the knowledge that the website is legitimate and able to enter any information into the website directly and securely through the mobile website's own login and authentication system.

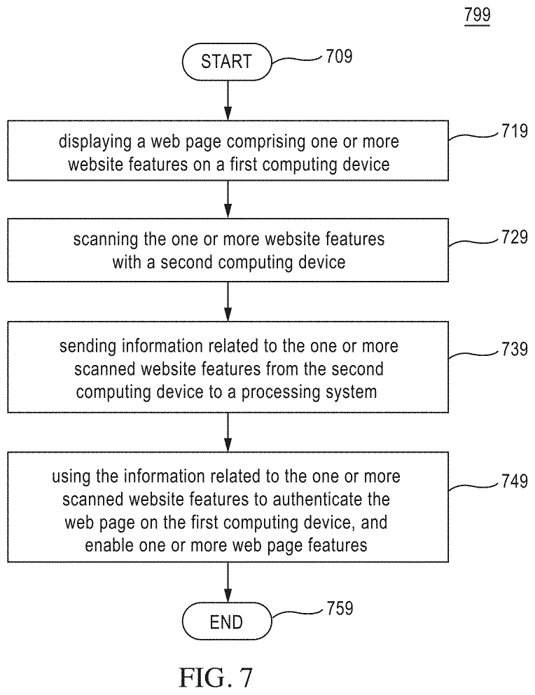

Turning now to FIG. 7, seen is a method 799 of digital authentication. The method starts at 709 and at 719 comprises displaying a web page comprising one or more website features on a first computing device such as, but not limited to the first computing device 100 and website 110 and website feature 120 seen in FIG. 1 and described herein. At 729 the method 799 comprises scanning the one or more website features 120 with a second computing device, such as, but not limited to the second computing device 250 seen in FIG. 2. At 739 the method 799 comprises sending information related to the one or more scanned website features 120 from the second computing device 250 to a processing system such as, but not limited to, the third party system 240. Finally, at step 749 the method 799 comprises using the information related to the one or more scanned website features 120 to authenticate the web page 210 displayed on the first computing device 200 and enable one or more web page components.

Though not shown in FIG. 7, it is contemplated that the second computing device 250 may comprise a camera and a scanning application. In such an instance, scanning the one or more website features 120 with a second computing device comprises scanning the one or more website features with the scanning application, with the scanning application utilizing the camera.

The method 799 may further comprise installing a scanning application on the second computing device 250 prior to scanning the one or more website features 120. Additional steps may further include providing user profile information to at least one of the second computing device 250 and the processing system 240 prior to scanning the one or more website features 120. It is contemplated that the one or more web page components comprise at least one of: automatically setting up a new account on the web page 110 with the user profile information, and completing a purchase on the web page 110. The user profile information may comprise login information related to the web page 110.

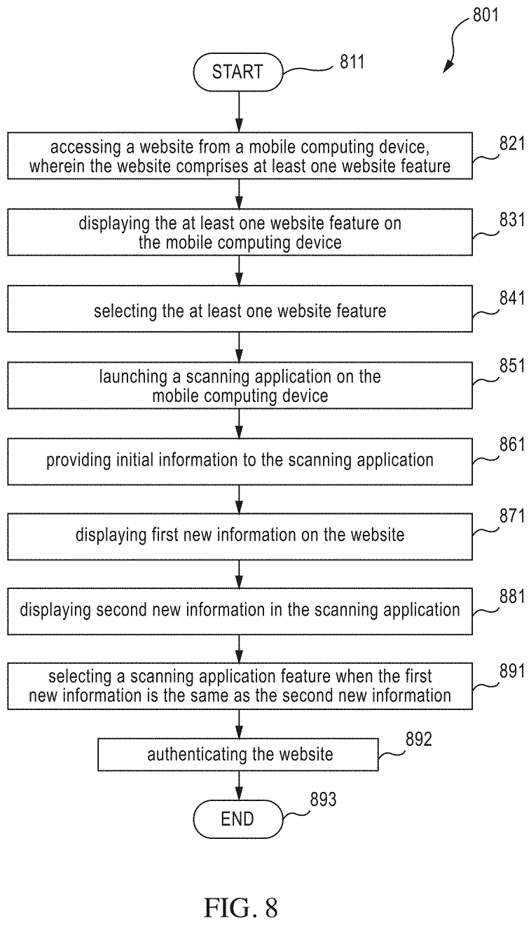

Turning now to FIG. 8, seen is a method 801 of providing digital authentication. The method starts at 811 and at 821. One method 801 comprises accessing a website from a mobile computing device, wherein the website comprises at least one website feature. At 831, the method 801 comprises displaying the at least one website feature on the mobile computing device. At 841 the method 801 comprises selecting the at least one website feature. At 851 the method 801 comprises launching a scanning application on the mobile computing device. At 861 the method 801 comprises providing initial information to the scanning application. At 871 the method 801 comprises displaying first new information on the website. At 881 the method 801 comprises displaying second new information in the scanning application. At 891 the method 801 comprises selecting a scanning application feature when the first new information is the same as the second new information. At 892 the method 801 comprises authenticating the website, and at 893 the method 801 comprises accessing one or more website features.

The method 801 step of selecting the at least one website feature comprises tapping the at least one website feature on the touch screen. It is also contemplated that the method 801 may further comprise downloading the scanning application on the mobile computing device prior to launching the scanning application on the mobile computing device. Furthermore, the initial information may comprise at least one of a pin number, a password, and biometric information. The second information may comprise an image related to the website.

It is further contemplated that using the information related to the one or more scanned website features to authenticate the web page on the first computing device comprises displaying a first image in the one or more website features, displaying a second image in the scanning application, and confirming that the first image and the second image are the same image. The method may also comprise providing additional authentication information to the processing system, wherein the additional authentication comprises at least one of biometric information and password information.

In some cases, multi-factor authentication (MFA) refers to an authentication method that requires a user to provide two or more verification factors to gain access to a resource, such as an application or a website, an online account (e.g., bank account, brokerage account, cryptocurrency account), a virtual private network (VPN), and cloud storage, to name a few non-limiting examples. MFA provides an added level of security to the traditional username/password authentication mechanism by requiring one or more additional verification factors, which serves to decrease the likelihood of a cyber-attack. In some cases, a rogue actor may gain access to a user's online account by hacking their login credentials (e.g., username/password). In some cases, the login credentials for a user may be stolen through one or more means, including, but not limited to, phishing (e.g., spoofing a legitimate website to trick a user into entering their login credentials; sending a fraudulent email purporting to be from a legitimate application/website to induce a user to reveal personal information, such as a password, credit card number, etc.) and/or brute force attack (e.g., trial-and-error to guess login information). In some cases, MFA requires additional verification information (also referred to as factors) besides username/password to confirm a user's identity. Some non-limiting examples of factors include knowledge factors (e.g., something the user knows, such as a password, a pin, an answer to a security question, one time password or OTP generated by a smartphone app or received as a text/email), possession factors (e.g., something the user possesses, such as a physical keycard or USB dongle, a smartphone, an access badge, a software token or certificate), inherence factors (e.g., something the user is, such as fingerprints, facial recognition, voice recognition, retina or iris scan, another biometric), location factors (e.g., user's IP address, geolocation), and time-based factors (e.g., time of day user is attempting to login and comparing it to user's calendar or their regular work hours to determine if there is an anomaly). In some cases, a factor, such as OTP, can fall under multiple categories. For instance, OTP can be both knowledge and possession, since a user needs to both know the OTP and have something in their possession (e.g., a smartphone) to retrieve the OTP. It should be noted that two-factor authentication (2FA) is a subset of MFA, since it only requires two factors across different categories.

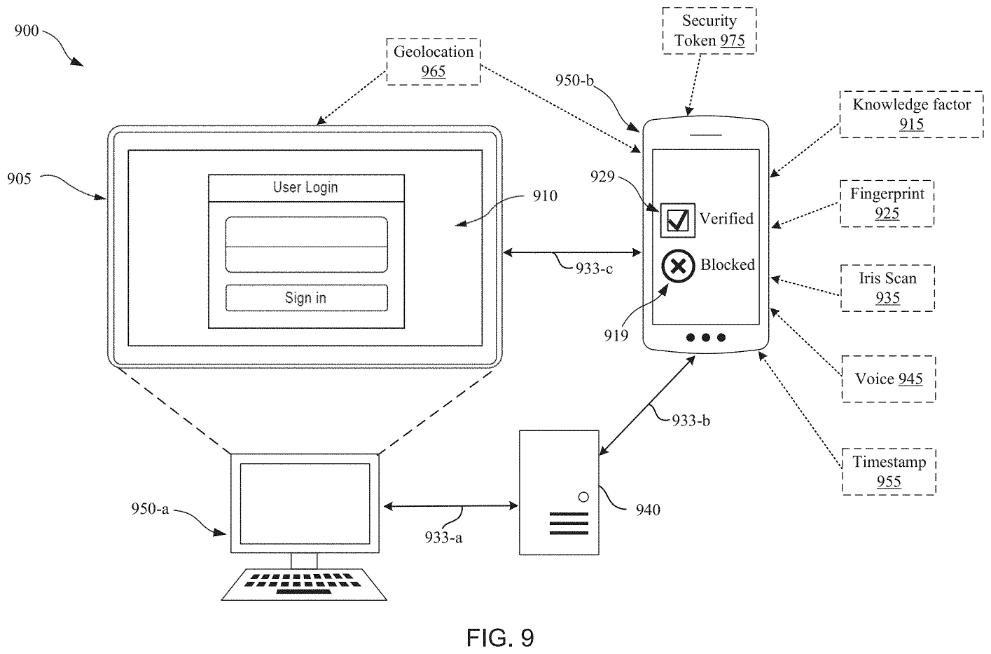

In some embodiments, MFA may also enable a user to authenticate the legitimacy of the website/application they are trying to access before entering their personal information, further described below. Fast Identity Online (FIDO) authentication refers to a set of standards for enabling phishing-resistant, passwordless, and multi-factor authentication. The FIDO standard defines a common way for browsers and online services to implement MFA. In some instances, it provides users with passwordless options, such as security keys, biometrics, and other mobile-device-based solutions to enhance security for end users and/or online services (e.g., an app or website). FIDO's Universal Second Factor (FIDO U2F) provides a standard means for interfacing with a second-factor hardware authenticator, such as a USB or Near-field Communications (NFC) dongle. FIDOs U2F standard defines cryptographic challenge-response protocols where a dongle with a private key can prove its identity to a pre-registered website (e.g., for a bank). In some cases, the dongle may interact with a user's computing device (e.g., laptop, smartphone, tablet) through a USB port, or wirelessly using NFC or Bluetooth. One non-limiting example of a dongle includes the YUBIKEY provided by YUBICO of Palo Alto, Calif. Generally, FIDO assumes three trusted and cooperating components, namely, the relaying party (e.g., server where the user authenticates, such as third-party system 140 in FIG. 1), the client (e.g., computing device 100 in FIG. 1, computing device 200 and/or 250 in FIG. 2, browser 905 in FIG. 9), and the authenticator (e.g., USB or NFC dongle, authenticator app on computing device, such as smartphone, tablet, desktop or laptop, etc.).

In some examples, FIDO incorporates a web authentication API (WebAuthn API) and a Client to Authenticator Protocol (CTAP). In some cases, a browser on the user's computing device implements a client-side API, such as the WebAuthn API. Additionally, the client-side API (e.g., WebAuthn API) accesses the authenticator using the CTAP. In some cases, the browser on the user's computing device provides the authenticator with the domain of the visited website. In FIDO's U2F, the domain of the visited website may be a function of the challenge-response protocol. In such cases, if the user is a victim of a phishing attack, the browser communicates the malicious domain to the authenticator, which then signs a challenge that is invalid to the relaying party, further described in detail below.

To authenticate a user, the relaying party passes a cryptographic challenge to the registered authenticator and evaluates the response to determine the authenticity of the secrets (e.g., private key) stored on the user's computing device (or hardware authenticator) and used to produce the response. In some cases, FIDO authentication requires an initial registration step, where a user is prompted to select a compliant authenticator (e.g., fingerprint scanner, voiceprint recorder, face ID, etc.) from the options available on the user's computing device that match the authenticating app or websites acceptance policy. The user may then unlock the authenticator using the applicable mechanism built into the authenticator, e.g., by providing a fingerprint, pressing a button on a second-factor device, such as a USB dongle, or entering a PIN. Once the authenticator is unlocked, a new and unique public/private cryptographic key pair may be generated by the authenticator. In some cases, the authenticator may be part of the user's computing device, for instance, a fingerprint reader. In some other cases, the authenticator may be an external piece of hardware (e.g., USB or NFC dongle) or software (e.g., a third-party authenticator app stored on the user's device). After the public/private cryptographic key pair are generated and stored on the user's hardware (e.g., computing device, USB dongle), the public key may be sent to the online service (e.g., website or app) and associated with the user's account. Further, the private key and any other sensitive data (e.g., biometric information for the user) related to authentication may be stored locally on the user's hardware. In some cases, authentication may require the user's computing device to prove possession of the private key to the authenticating service (i.e., relaying party) by successfully responding to a cryptographic challenge. In some cases, the private key may only be accessible after the user is successfully authenticated (i.e., on the user's computing device) using the registered authenticator, for instance, via the fingerprint reader, entering a PIN, voice recognition, iris or retina scan, or interfacing with the hardware authenticator (e.g., USB or NFC dongle), to name a few non-limiting examples. After this preliminary authentication by the registered authenticator, the user's computing device selects the private key associated with the service (i.e., website/application), cryptographically signs the service's challenge, and sends a response containing the signed challenge to the service. In some examples, the relaying party or service may verify that the user's computing device possesses the correct private key using the stored public key before logging in the user. As can be appreciated, in case of phishing, the domain (e.g., web address) sent by the browser to the authenticator is that of the rogue party's website. In such cases, the relaying party (i.e., legitimate website or app) does not grant access to the rogue party, since the challenge response relayed by the rogue party does not match the one expected by the website.

Turning now to FIG. 9, which illustrates an example of a process flow 900 for MFA, according to various aspects of the disclosure. FIG. 9 depicts a login screen 905, a first computing device 950-a, a second computing device 950-b, and a server 940. The server 940 may be associated with a third-party system, such as a relaying party where the user authenticates. The third-party system may be similar or substantially similar to the third-party system 140 and/or 240 described in relation to FIGS. 1 and/or 2. Additionally, or alternatively, the first computing device 950-a and the second computing device 950-b implement one or aspects of the computing device(s) 200 and/or 250 in FIG. 2

In some cases, to begin authentication, a user may input their login credentials 910 (e.g., username, password) into the login screen 905 displayed on the computing device 950-a. In some examples, the login credentials 910 may be relayed from the computing device 950-a to the server 940 in a data flow 933-a. Other types of information (e.g., geolocation information 965, timestamp information 955) may also be relayed to the server 933-a in data flow 933-a. In some cases, the server 940 may prompt the user for additional verification information (i.e., factors) on the second computing device 950-b, for instance, via dataflow 933-b. As noted above, MFA may involve verifying a user using two or more factors, where the two or more factors are from at least two different categories (e.g., knowledge factors, such as an answer to a security question, a PIN, an OTP; inherence factors, such as fingerprint 925, iris scan 935, voice 945; possession factors, such as security token 975, which may be a USB or NFC dongle, or a software token/certificate).

In some cases, the server 940 may prompt the user to present at least one knowledge factor 915, such as an OTP, a PIN, etc., from the second computing device 950-b. In one non-limiting example, an OTP (e.g., a 4-6 character long numeric or alphanumeric code) may be displayed via a pop-up notification on the second computing device 950-b. The user may then input the OTP into the first computing device 950-a to get logged in. In some other cases, the OTP may be displayed on the first computing device 950-a and the user may need to enter it into the second computing device 950-b for authentication. Additionally, or alternatively, the server 940 may request the user to insert a physical token (e.g., USB-C dongle) into the second computing device 950-b upon which an OTP or code is displayed on the second computing device 950-b. The user may then input the OTP or code into the first computing device 950-a, which relays it to the server 940. After the server verifies that the OTP or code input into the first computing device 950-a matches the one displayed on the second computing device 950-b, the user may be authenticated. In some other cases, the user may utilize one or more biometrics sensors, recorders, or scanners on the second computing device 950-b for verification of one or more inherence factors (e.g., a scan of their fingerprint 925, an iris scan 935, voice recognition 945). In some cases, an authenticator app installed on the second computing device 950-b may utilize the one or more inherence factors to verify the user's identity, following which it provides the user with a code or OTP to input in the first computing device. It should be noted that, the authenticator app may be associated with or linked to the relaying party (e.g., server 940). In some cases, when the user attempts to login from the first computing device 950-a, the server may display a pop-up notification on the second computing device 950-b, for instance, asking the user if they are attempting to login from the first computing device 950-a. The user may click a “Yes” or “No” checkbox or radio button on the second computing device 950-b to verify that the login attempt received by the server 940 is legitimate. In some cases, the user may need to provide biometrics information (i.e., to verify one or more inherence factors) on the second computing device 950-b before they can respond to the “Yes” or “No” prompt. In this way, MFA may thwart a malicious login even if the user's computing device (e.g., computing device 950-b) is stolen or lost.

Aspects of this disclosure also support adaptive authentication (also referred to as risk-based authentication). In some examples, one or more additional factors (e.g., geolocation information 965, timestamp information 955) may be evaluated to assign a level of risk associated with the login attempt. For instance, a higher level of risk may be assigned if the login attempt is from a different geographic region (e.g., city, state, country) than the one from previous login attempts. In other cases, the login attempt may be blocked if the geolocation information 965 associated with the login is not on a pre-defined whitelist (e.g., within the United States, within a particular state, such as Colorado). In some cases, the server 940 may compare the geolocation information 965 received from the first computing device 950-a and the second computing device 950-b. Any discrepancies between the geolocation information 965 for the two computing devices 950 may be flagged and the login attempt may be blocked. In some cases, the login attempt may be assigned a higher risk level, for instance, if it is received outside of normal business hours (e.g., 9 am to 6 pm from Monday to Friday), or hours that are atypical for the user (e.g., 2 am on a weekday, 9 am on a weekend, etc.), to name two non-limiting examples. In some cases, information about the computing device 950-a, for instance, if it is a registered device or a device previously used by the user, may also be evaluated to assign a risk level. In yet other cases, information about the connection (e.g., is computing device 950-a and/or 950-b connected to a private network, such as a home network or an enterprise network, or a public network, such as a library or a coffee shop) may also be utilized to assign a risk level. It should be noted that a higher risk level may not automatically imply that the login attempt will be blocked. For instance, in some examples, a higher risk level may be used to determine whether or not the user should be prompted for additional authentication factors. In one non-limiting example, a user may be prompted for an OTP in addition to the login credentials, for instance, when the risk level is low. Further, a user may be prompted for an OTP, a fingerprint 925 or iris scan 935 (e.g., before the OTP is displayed), and the login credentials, when the risk level is high. In another non-limiting example, the user may need to respond to two security questions (e.g., as opposed to one) when the risk level is high.

Once the user is authenticated using MFA, the server 940 may instruct the computing device 950-b to display a verified message 929 for the user, indicating that the authentication was successful. In some examples, the relaying party (e.g., server 940) may also automatically login the user on the first computing device 905. Alternatively, if MFA was unsuccessful, the computing device 950-b may display a blocked message 919 and the server 940 may block the login attempt. While FIG. 9 depicts the verified and blocked messages 929 and 919 as being displayed on the second computing device 950-b, this illustration is not intended to be limiting. For instance, in some cases, the messages may be displayed on both the first and second computing devices 950, or alternatively, only on the first computing device 950-a.

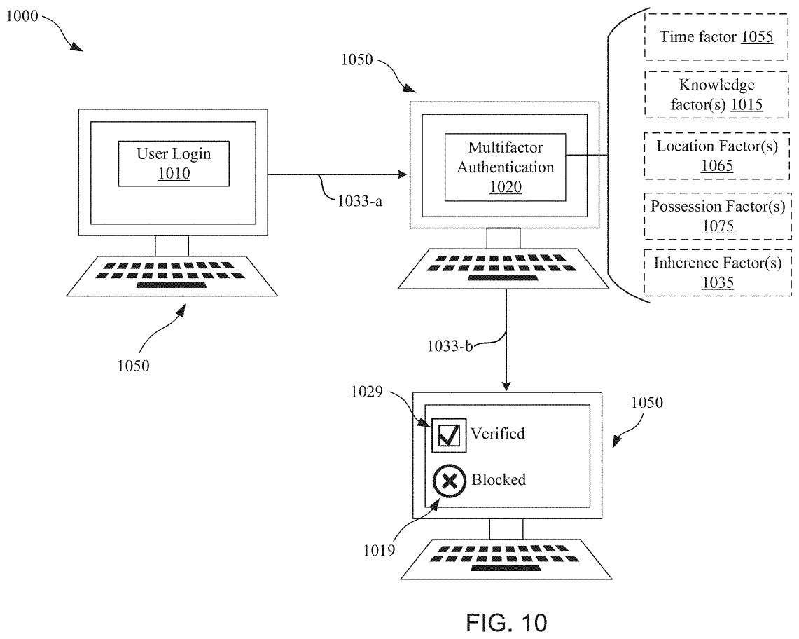

In some cases, MFA may be implemented using a single computing device, as further described in relation to FIG. 10. FIG. 10 illustrates an example of a process flow 1000, according to an embodiment of the disclosure. Process flow 1000 may be implemented using a single computing device 1050, which may be a laptop, a smartphone, a netbook, a tablet, or any other computing device. Computing device 1050 may be similar or substantially similar to computing device 100 in FIG. 1. Further, process flow 1000 may implement one or more aspects of the process flow 900 described above in relation to FIG. 9.

In some examples, the computing device 1050 may receive user login information 1010 from a user, where the user login information may comprise one or more of a username and a password. The computing device 1050 may relay the received user login information 1010 to a third-party system (e.g., shown as server 940 in FIG. 9, third party system 140 in FIG. 1). In some cases, the third-party system may instruct the computing device 1050 to begin multi-factor authentication (MFA) 1020. As described above, MFA may comprise authenticating/verifying a user based on one or more additional factors besides user login information. Some non-limiting examples of factors include a time factor 1055 (e.g., used for adaptive or risk-based authentication), knowledge factor(s) 1015 (e.g., what the user knows, such as an OTP, a PIN, an answer to a security question, etc.), location factor 1065 (e.g., used for adaptive or risk-based authentication), possession factor(s) 1075 (e.g., what the user has, such as a hardware or software security token), inherence factor(s) 1035 (e.g., biometrics, such as fingerprint scan, iris or retina scan, voice recognition, facial recognition). These factors may be similar or substantially similar to the ones described throughout this disclosure, including at least in relation to FIG. 9.

In some cases, the knowledge factor 1015 may comprise an image, and MFA 1020 may comprise the user correctly identifying the image from a set of images. The image may have been previously selected by the user, such as, but not limited to, during the installation/set-up of the account they are trying to access from the computing device 1050. Such an image may display any type of picture (e.g., a house, animal, sporting equipment, mountains, etc.) for this authentication step. In some cases, MFA 1020 may comprise the computing device 1050 and the relaying party (i.e., third-party system) exchanging information pertaining to the one or more factors, for instance, over a wired or wireless communication link. After MFA 1020, the relaying party may transmit the authentication result to the computing device 1050 for display to the user. For instance, the computing device 1050 may display a verified message 1029 when MFA 1020 is successful and a blocked message 1019 when MFA 1020 is unsuccessful. In some cases, MFA 1020 may be unsuccessful even when the user login information 1010 is accurate. A user may fail MFA for a multitude of reasons, such as, but not limited to, entering an incorrect PIN, code, OTP, and/or security question answer; when the risk level assessed based on time factor 1055 and/or location factor 1065 exceeds a threshold risk level; when the biometrics information does not match the one previously registered for the user, maybe an incorrect fingerprint scan due to sweat/grease, to name a few non-limiting examples.

It should be noted that, the process flows 900 and/or 1000 described above may incorporate an authentication standard, such as FIDO U2F, or any other authentication standard known in the art. In such cases, the user may or may not input their login information into the computing device (e.g., computing device 950, computing device 1050). In one non-limiting example, the user's login information and public/private key pair may be stored by an authenticator (e.g., a hardware authenticator, such as a USB dongle; a software authenticator on the user's device, such as WebAuthnAPI). Further, when the user arrives at the login screen (e.g., login screen 950) for the service/website, the authenticator extracts the domain (e.g., URL or web address) from the web browser, signs the cryptographic challenge from the relaying party (e.g., server 940), and transmits the challenge response to the relaying party. In some cases, the cryptographic challenge is signed using the private key associated with the user's account (e.g., private key for user A for bank B). After the relaying party verifies that the authenticator on the user's computing device possesses the valid private key, the relaying party automatically authenticates and logs the user in to the service. In this way, security for both end users and online services may be enhanced without the use of knowledge factors. For instance, a user may be able to verify the legitimacy of the online website/service they are trying to access without entering any personal login information. Further, the online service may be able to seamlessly verify multiple factors (e.g., both inherence and possession, since the user may need to provide fingerprint information to the hardware authenticator, i.e., in their possession, before the private key is made available) to authenticate the user.

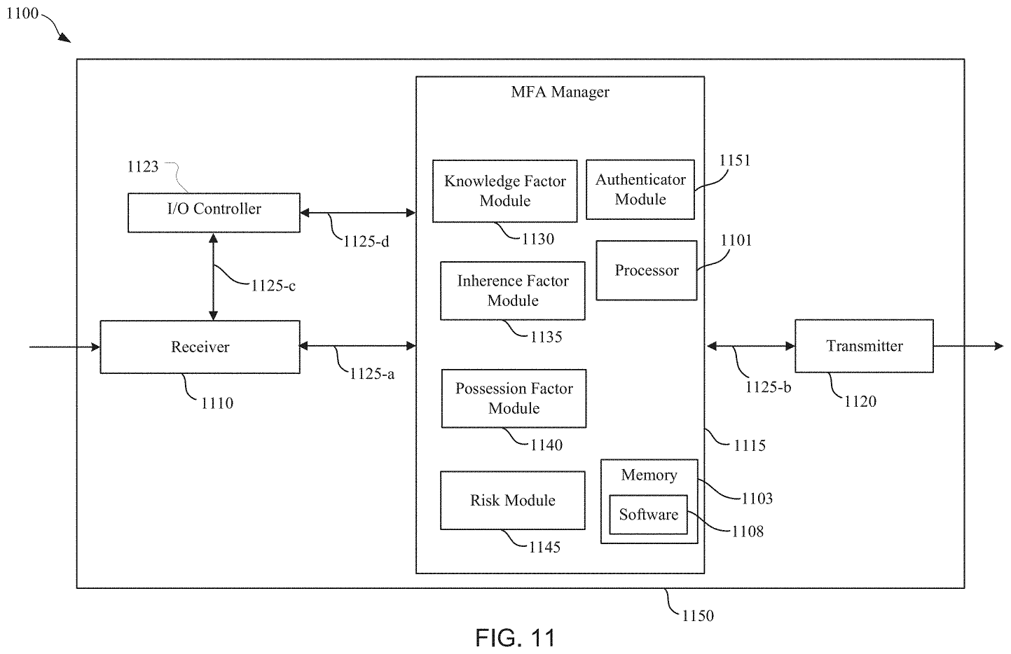

FIG. 11 illustrates a block diagram 1100 of a computing system 1150 for MFA, according to various aspects of the disclosure. The computing system 1150 may be similar or substantially similar to any of the computing systems or devices described herein, such as computing device(s) 100, 950-a, 950-b, and/or 1050.

Computing system 1150 may include a receiver 1110, a multi-factor authentication (MFA) manager 1115, and a transmitter 1120. Computing system 1150 may also include a processor 1101, a memory 1103, a software 1108, and an input/output (I/O) controller 1123. Memory 1103 may include random access memory (RAM) read only memory (ROM). The memory 1103 may store computer-readable, computer-executable software 1108 including instructions that, when executed, cause the processor to perform various functions described herein. In some cases, the memory 1103 may contain, among other things, a basic input/output system (BIOS) which may control basic hardware and/or software operation such as the interaction with peripheral components or devices. Software 1108 may include code to implement aspects of the present disclosure, including code to support digital authentication, such as, but not limited to, MFA. Software 1108 may be stored in a non-transitory computer-readable medium such as system memory or other memory. In some cases, the software 1108 may not be directly executable by the processor but may cause a computer (e.g., when compiled and executed) to perform functions described herein. Each of these components of computing system 1150 may be in communication with one another (e.g., via one or more buses, such as buses 1125-a, 1125-b, 1125-c, 1125-d). In some cases, the receiver 1110 and the transmitter 1120 may collectively be referred to as a transceiver.

Receiver 1110 may receive information such as information for rendering/displaying a login screen for an application on the computing system 1150, a domain (e.g., URL or web address) associated with an application or website from a web server hosting the application or website, a challenge from a processing system (e.g., shown as processing or third-party system 240 in FIG. 2), and/or a public-private key pair comprising a private key and a public key, to name a few non-limiting examples. Information may be passed on to other components of the device.

MFA manager 1115 may comprise one or more of a knowledge factor module 1130, an inherence factor module 1135, a possession factor module 1140, an authenticator module 1151, and a risk module 1145. One or more of these modules may be optional, and the examples listed herein are not intended to be limiting.

In some examples, the authenticator module 1151 may provide an authenticator for use with the computing device or system 1150. The authenticator may be one of a biometrics authenticator (e.g., an authenticator for confirming a user's identity using biometrics information, such as fingerprint scan, voice scan, etc.), a hardware authenticator (e.g., a USB or NFC dongle, may be used to store the public-private key pair associated with the user's account), or a software authenticator (e.g., WebAuthnAPI).

In some cases, the computing system 1150 may be configured to display a login screen, where the login screen is associated with an application (e.g., a mobile banking app, an email application). Next, the MFA manager 1115 may receive a first set of factors at the computing device 1150. The first set of factors may comprise one of knowledge factors, inherence factors, and possession factors. In some cases, the knowledge factor module 1130 may receive knowledge factors, where the knowledge factors selected from a group consisting of user credential information, a PIN, a passcode, an answer to a security question, and a one-time password (OTP). Additionally, or alternatively, the inherence factor module 1135 may receive inherence factors, such as biometric information, where the biometric information is selected from a group consisting of a fingerprint scan, voice scan, retina scan, iris scan, and behavioral analysis information for the user. Similarly, the possession factor module 1140 may receive possession factors, where the possession factors are selected from a group consisting of a physical keycard, USB dongle, a Near Field Communication (NFC) dongle, a mobile device, an access badge, a one-time password (OTP), a private key, and a software token or certificate.

In some examples, the transmitter 1120 may send information related to the first set of factors to a processing system (e.g., shown as processing system or third-party system 240 in FIG. 2). In some cases, the processing system may prompt the user to send a second set of factors, for instance, from the computing system 1150, or alternatively, from another computing system (e.g., shown as second computing device 950-b in FIG. 9). The second set of factors may comprise another of the knowledge factors, inherence factors, and possession factors. In other words, the second set of factors may be different from the first set of factors.

In some examples, the processing system may use information related to one or more of the first set of factors and the second set of factors to authenticate the application on the computing system 1150. In some cases, authenticating the application on the computing device 1150 comprises providing a domain (e.g., URL, web address) associated with the application to the authenticator module 1151 on the computing device 1150. In some examples, the authenticator module 1151 optionally accesses the first set of factors from the computing device 1150. The authenticator module 1151 may store public-private key pairs for a plurality of user accounts. Accessing the first set of factors (e.g., user credentials information) may allow the authenticator to select the private key associated with the account the user is attempting to access. In other cases, the first set of factors comprise a private key stored on the authenticator. As described above, authenticating the application on computing device 1150 may mitigate the likelihood of a phishing or man-in-the-middle attack. In some cases, the authenticator module 1151 and the processing system may authenticate the application (i.e., verify its legitimacy) before the user is authenticated to the application. In some cases, authenticating the application on the computing device 1150 further comprises receiving, by authenticator, a challenge from the processing system. The authenticator module 1151 may sign the challenge, where the signing is based at least in part on the domain associated with the web page (or the application) and the first set of factors (e.g., private key). In some cases, the signing is further based in part on the public-private key associated with the user account, where the private key is stored by the authenticator and the public key is stored by the processing system. This public-private key pair may have been generated when the user initially registered the authenticator for use with the website/application. In some cases, the processing system receives the signed challenge from the authenticator module 1151 and determines whether the authenticator possess the private key based in part on the received signed challenge. If the signed challenge matches the one expected by the processing system, the user may be automatically logged into the application, which may allow the user to access one or more components or features of the application. Conversely, if the domain the user is trying to access is associated with a rogue party (e.g., phishing, man-in-the-middle attack), the challenge signed by the authenticator may not match the one expected by the processing system. In such cases, the processing system may deny the user access to the application (or web page) and/or block the user's account based on identifying the security breach.

In some embodiments, the authenticator module 1151 may additionally receive a third set of factors comprising one of biometrics information or user credential information for the user, where the user credential information may comprise one or more of a username, a password, a PIN, and a passcode. In some cases, the third set of factors may be specific to the authenticator, for instance, to enable the user to access the authenticator. In some cases, if the authenticator is a hardware authenticator, a user may need to tap a button on the hardware authenticator or scan their fingerprint on a fingerprint reader of the authenticator to confirm that they are in possession of the authenticator. In such cases, the second set of factors may comprise at least the private key, or optionally, the public key and the private key. In some circumstances, the second set of factors (e.g., the private key) may be unlocked based in part on receiving the third set of factors. The authenticator module 1151 may store the first set of factors (e.g., user credentials information for an application or web site) and the second set of factors (e.g., private key or public-private key pair) and link the first and the second set of factors to the user account for the application or web site. Such a design may enable a user to a) verify that the application or website they are trying to access is legitimate and b) automatically login to the website or application without having to provide user credentials information each time. For instance, in one non-limiting example, once the authenticator has linked the user credential information and private key for an online service (e.g., application or website), the user may be automatically logged in upon arriving at the online service based on the authenticator signing the challenge using the domain, the private key, and/or the user credentials information.

In some examples, the MFA manager 1115 may further comprise the risk module 1145. In some cases, the first set of factors may comprise a time factor or location factor, as previously described in relation to FIGS. 9 and 10. Additionally, or alternatively, the second set of factors may comprise another of a time factor or location factor. Risk module 1145 may determine a risk level based on assessing at least the first set of factors. It should be noted that, the risk module 1145 may be optional. Alternatively, the processing system may include a risk module for determining a risk level associated with the login attempt. This risk level may be used to determine if additional authentication factors are needed to verify the user's identity. In some examples, the processing system may receive a third set of factors from one or more of the computing device 1150, or alternatively, another computing device (e.g., shown as second computing device 950-b in FIG. 9) based on determining the risk level exceeds a threshold. The processing system may use the information related to the first, second, and third set of factors to authenticate the application on the computing device 1150, authenticate the user on the login screen displayed on the computing device, or a combination thereof.

In some embodiments, the processor 1101 may include an intelligent hardware device (e.g., a general-purpose processor, a digital signal processor or DSP, a central processing unit or CPU, a microcontroller, an ASIC, an FPGA, a programmable logic device, a discrete gate or transistor logic component, a discrete hardware component, or any combination thereof). In some cases, processor 1101 may be configured to operate a memory array using a memory controller. In other cases, a memory controller may be integrated into processor 1101. Processor 1101 may be configured to store computer-readable instructions stored in a memory to perform various functions (e.g., functions or tasks supporting multi-factor authentication or MFA).

In some cases, the transmitter 1120 may transmit signals generated by other components of the device. In some examples, the transmitter 1120 may be collocated with the receiver 1110 in a transceiver module. While not shown, the receiver 1110 and/or the transmitter 1120 may include a single antenna, or it may include a set of antennas.

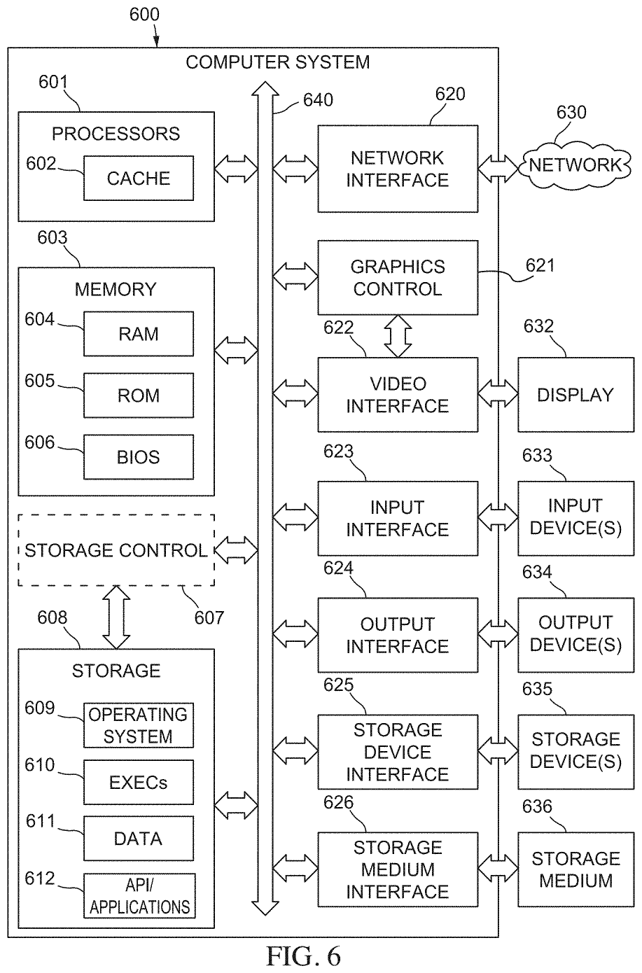

The systems and methods described herein include various computing devices such as, but not limited to, the computing first computing device 100 and second computing device 250. The computing devices described herein may also be referred to as a computing system or a computer system. FIG. 6 shows a diagrammatic representation of one embodiment of a computer system 600 within which a set of instructions can be executed to cause a device to perform or execute any one or more of the aspects and/or methodologies of the present disclosure. The components in FIG. 6 are examples only and do not limit the scope of use or functionality of any hardware, software, firmware, embedded logic component, or a combination of two or more such components implementing particular embodiments of this disclosure. Some or all of the illustrated components can be part of the computer system 600. For instance, the computer system 600 can be a general purpose computer (e.g., a laptop computer) or an embedded logic device (e.g., an FPGA), to name just two non-limiting examples.

Computer system 600 includes at least one processor 601 such as a central processing unit (CPU) or an FPGA to name two non-limiting examples. Any of the subsystems described throughout this disclosure could embody the processor 601. The computer system 600 may also comprise a memory 603 and a storage 608, both communicating with each other, and with other components, via a bus 640. The bus 640 may also link a display 632, one or more input devices 633 (which may, for example, include a keypad, a keyboard, a mouse, a stylus, touch screen, etc.), one or more output devices 634, one or more storage devices 635, and various non-transitory, tangible computer-readable storage media/medium 636 with each other and with one or more of the processor 601, the memory 603, and the storage 608. All of these elements may interface directly or via one or more interfaces or adaptors to the bus 640. For instance, the various non-transitory, tangible computer-readable storage media 636 can interface with the bus 640 via storage medium interface 626. Computer system 600 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 601 (or central processing unit(s) (CPU(s))) optionally contains a cache memory unit 602 for temporary local storage of instructions, data, or computer addresses. Processor(s) 601 are configured to assist in execution of computer-readable instructions stored on at least one non-transitory, tangible computer-readable storage medium. Computer system 600 may provide functionality as a result of the processor(s) 601 executing software embodied in one or more non-transitory, tangible computer-readable storage media, such as memory 603, storage 608, storage devices 635, and/or storage medium 636 (e.g., read only memory (ROM)). For instance, the methods 799, 801 shown in FIGS. 7 and 8 may be embodied in one or more non-transitory, tangible computer-readable storage media. The non-transitory, tangible computer-readable storage media (or medium) may store software comprising instructions that implements particular embodiments, such as the methods 799, 801 and processor(s) 601 may execute the software. Memory 603 may read the software from one or more other non-transitory, tangible computer-readable storage media (such as mass storage device(s) 635, 636) or from one or more other sources through a suitable interface, such as network interface 620. Any of the subsystems herein disclosed could include a network interface such as the network interface 620. The software may cause processor(s) 601 to carry out one or more processes or one or more steps of one or more processes described or illustrated herein. Carrying out such processes or steps may include defining data structures stored in memory 603 and modifying the data structures as directed by the software. In some embodiments, an FPGA can store instructions for carrying out functionality as described in this disclosure (e.g., the methods 799, 801). In other embodiments, firmware includes instructions for carrying out functionality as described in this disclosure (e.g., the methods 799, 801).

The memory 603 may include various components (e.g., non-transitory, tangible computer-readable storage media) including, but not limited to, a random access memory component (e.g., RAM 604) (e.g., a static RAM “SRAM”, a dynamic RAM “DRAM, etc.), a read-only component (e.g., ROM 605), and any combinations thereof. ROM 605 may act to communicate data and instructions uni-directionally to processor(s) 601, and RAM 604 may act to communicate data and instructions bi-directionally with processor(s) 601. ROM 605 and RAM 604 may include any suitable non-transitory, tangible computer-readable storage media. In some instances, ROM 605 and RAM 604 include non-transitory, tangible computer-readable storage media for carrying out the methods 799, 801. In one example, a basic input/output system 606 (BIOS), including basic routines that help to transfer information between elements within computer system 600, such as during start-up, may be stored in the memory 603.

Fixed storage 608 is connected bi-directionally to processor(s) 601, optionally through storage control unit 607. Fixed storage 608 provides additional data storage capacity and may also include any suitable non-transitory, tangible computer-readable media described herein. Storage 608 may be used to store operating system 609, EXECs 610 (executables), data 611, API applications 612 (application programs/interfaces), and the like. Often, although not always, storage 608 is a secondary storage medium (such as a hard disk) that is slower than primary storage (e.g., memory 603). Storage 608 can also include an optical disk drive, a solid-state memory device (e.g., flash-based systems), or a combination of any of the above. Information in storage 608 may, in appropriate cases, be incorporated as virtual memory in memory 603.

In one example, storage device(s) 635 may be removably interfaced with computer system 600 (e.g., via an external port connector (not shown)) via a storage device interface 625. Particularly, storage device(s) 635 and an associated machine-readable medium may provide nonvolatile and/or volatile storage of machine-readable instructions, data structures, program modules, and/or other data for the computer system 600. In one example, software may reside, completely or partially, within a machine-readable medium on storage device(s) 635. In another example, software may reside, completely or partially, within processor(s) 601.

Bus 640 connects a wide variety of subsystems. Herein, reference to a bus may encompass one or more digital signal lines serving a common function, where appropriate. Bus 640 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 600 may also include an input device 633. In one example, a user of computer system 600 may enter commands and/or other information into computer system 600 via input device(s) 633. Examples of an input device(s) 633 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 633 may be interfaced to bus 640 via any of a variety of input interfaces 623 (e.g., input interface 623) including, but not limited to, serial, parallel, game port, USB, FIREWIRE, THUNDERBOLT, or any combination of the above.

In particular embodiments, when computer system 600 is connected to network 630, computer system 600 may communicate with other devices, such as mobile devices and enterprise systems, connected to network 630. Communications to and from computer system 600 may be sent through network interface 620. For example, network interface 620 may receive incoming communications (such as requests or responses from other devices) in the form of one or more packets (such as Internet Protocol (IP) packets) from network 630, and computer system 600 may store the incoming communications in memory 603 for processing. Computer system 600 may similarly store outgoing communications (such as requests or responses to other devices) in the form of one or more packets in memory 603 and communicated to network 630 from network interface 620. Processor(s) 601 may access these communication packets stored in memory 603 for processing.

Examples of the network interface 620 include, but are not limited to, a network interface card, a modem, and any combination thereof. Examples of a network 630 or network segment 630 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 630, may employ a wired and/or a wireless mode of communication. In general, any network topology may be used.

Information and data can be displayed through a display 632. Examples of a display 632 include, but are not limited to, a liquid crystal display (LCD), an organic liquid crystal display (OLED), a cathode ray tube (CRT), a plasma display, and any combinations thereof. The display 632 can interface to the processor(s) 601, memory 603, and fixed storage 608, as well as other devices, such as input device(s) 633, via the bus 640. The display 632 is linked to the bus 640 via a video interface 622, and transport of data between the display 632 and the bus 640 can be controlled via the graphics control 621.

In addition to a display 632, computer system 600 may include one or more other peripheral output devices 634 including, but not limited to, an audio speaker, a printer, and any combinations thereof. Such peripheral output devices may be connected to the bus 640 via an output interface 624. Examples of an output interface 624 include, but are not limited to, a serial port, a parallel connection, a USB port, a FIREWIRE port, a THUNDERBOLT port, and any combinations thereof.

In addition or as an alternative, computer system 600 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein (e.g., the methods 799, 801) may be embodied directly in hardware, in a software module executed by a processor, a software module implemented as digital logic devices, or in a combination of these. A software module may reside in RAM memory, flash memory, ROM memory, EPROM memory, EEPROM memory, registers, hard disk, a removable disk, a CD-ROM, or any other form of non-transitory, tangible computer-readable storage medium known in the art. An exemplary non-transitory, tangible computer-readable storage medium is coupled to the processor such that the processor can read information from, and write information to, the non-transitory, tangible computer-readable storage medium. In the alternative, the non-transitory, tangible computer-readable storage medium may be integral to the processor. The processor and the non-transitory, tangible computer-readable storage medium may reside in an ASIC. The ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method of digital authentication, comprising:
providing an authenticator for use with a first computing device;
displaying a login screen on the first computing device, wherein the login screen is associated with an application;
receiving a first set of factors at the first computing device;
sending information related to the first set of factors to a processing system;
receiving a second set of factors from one of the first computing device or a second computing device; and
using information related to one or more of the first set of factors and the second set of factors to:
authenticate the application on the first computing device,
authenticate a user on the login screen displayed on the first computing device, wherein authenticating the user comprises enabling one or more components of the application, the one or more components comprising at least one of (a) linking a user account associated with the user to the second set of factors, (b) completing a purchase on the application, or (c) automatically logging the user into the application,
or a combination thereof.

2. The method of claim 1, wherein the first set of factors comprise one of knowledge factors, inherence factors, and possession factors.

3. The method of claim 2, wherein the second set of factors comprise another one of knowledge factors, inherence factors, and possession factors, and wherein the first set of factors are different from the second set of factors.

4. The method of claim 3, wherein:
the knowledge factors are selected from a group consisting of user credential information, a PIN, a passcode, an answer to a security question, and a one-time password;
the inherence factors comprise biometric information, the biometric information selected from a group consisting of a fingerprint scan, voice scan, retina scan, iris scan, and behavioral analysis information for the user; and
the possession factors are selected from a group consisting of a physical keycard, USB dongle, a Near Field Communication (NFC) dongle, a mobile device, an access badge, a one-time password (OTP), a private key, and a software token or certificate.

5. The method of claim 1, wherein authenticating the application on the first computing device comprises:
providing a domain associated with the application to the authenticator on the first computing device;
accessing, by the authenticator, the first set of factors from the first computing device;
receiving, by the authenticator, a challenge from the processing system; and
signing, by the authenticator, the challenge, wherein the signing is based at least in part on the domain associated with the application and the first set of factors.

6. The method of claim 5, wherein the signing is further based in part on a public-private key pair associated with the user account, the public-private key pair including a private key stored by the authenticator and a public key stored by the processing system, and wherein automatically logging the user into the application comprises:
receiving, by the processing system, the signed challenge from the authenticator;
determining, by the processing system, possession of the private key by the authenticator based in part on the received signed challenge; and
verifying the user based in part on determining that the authenticator possesses the private key corresponding to the public-private key pair.

7. The method of claim 6, further comprising:
receiving, by the authenticator, a third set of factors, wherein the third set of factors comprise one of biometrics information or user credential information for the user, the user credential information comprising one or more of a username, a password, a PIN, and a passcode, and
wherein the second set of factors comprise at least one of the public key or the private key,
and wherein the second set of factors are unlocked based in part on receiving the third set of factors.

8. The method of claim 7, wherein the authenticator is one of a biometrics authenticator, a hardware authenticator, or a software authenticator.

9. The method of claim 8, further comprising:
storing, by the authenticator, the first set of factors and the second set of factors, wherein the storing comprises linking the first set of factors and the second set of factors to the user account for the application.

10. The method of claim 1, wherein the first set of factors comprise a time factor or a location factor.

11. The method of claim 10, further comprising:
determining a risk level based on assessing the first set of factors;
receiving a third set of factors from one of the first computing device and the second computing device based on determining the risk level exceeds a threshold; and
using information related to the first, second, and third set of factors to authenticate the application on the first computing device, authenticate the user on the login screen displayed on the first computing device, or a combination thereof.

12. The method of claim 1, wherein the second set of factors are received from the second computing device.

13. A plurality of non-transitory, tangible, computer-readable storage medium across a plurality of devices, wherein the plurality of non-transitory, tangible, computer-readable storage medium are encoded with processor-readable instructions which, together, perform a method of digital authentication, the method comprising:
providing an authenticator for use with a first computing device;
displaying a login screen on the first computing device, wherein the login screen is associated with an application;
receiving a first set of factors at the first computing device;
sending information related to the first set of factors to a processing system;
receiving a second set of factors from one of the first computing device or a second computing device; and
using information related to one or more of the first set of factors and the second set of factors to:
authenticate the application on the first computing device, and
authenticate a user on the login screen displayed on the first computing device, wherein authenticating the user comprises enabling one or more components of the application, the one or more components comprising at least one of (a) linking a user account associated with the user to the second set of factors, (b) completing a purchase on the application, or (c) automatically logging the user into the application,
or a combination thereof.

14. The non-transitory tangible computer-readable storage medium of claim 13, wherein the first set of factors comprise one of knowledge factors, inherence factors, and possession factors.

15. The non-transitory tangible computer-readable storage medium of claim 14, wherein the second set of factors comprise another one of knowledge factors, inherence factors, and possession factors, and wherein the first set of factors are different from the second set of factors.

16. The non-transitory, tangible computer-readable storage medium of claim 15, wherein:
the knowledge factors are selected from a group consisting of user credential information, a PIN, a passcode, an answer to a security question, and a one-time password;
the inherence factors comprise biometric information, the biometric information selected from a group consisting of a fingerprint scan, voice scan, retina scan, iris scan, and behavioral analysis information for the user; and
the possession factors are selected from a group consisting of a physical keycard, USB dongle, a Near Field Communication (NFC) dongle, a mobile device, an access badge, a one-time password (OTP), a private key, and a software token or certificate.

17. The non-transitory, tangible computer-readable storage medium of claim 13, wherein authenticating the application on the first computing device comprises:
providing a domain associated with the application to the authenticator on the first computing device;
accessing, by the authenticator, the first set of factors on the first computing device;
receiving, by the authenticator, a challenge from the processing system; and
signing, by the authenticator, the challenge, wherein the signing is based at least in part on the domain associated with the application and the first set of factors.

18. The non-transitory, tangible computer-readable storage medium of claim 17, wherein the signing is further based in part on a public-private key pair associated with the user account, the public-private key pair including a private key stored by the authenticator and a public key stored by the processing system, and wherein automatically logging the user into the application comprises:
receiving, by the processing system, the signed challenge from the authenticator;
determining, by the processing system, possession of the private key by the authenticator based in part on the received signed challenge; and
verifying the user based in part on determining that the authenticator possesses the private key corresponding to the public-private key pair.

19. The non-transitory, tangible computer-readable storage medium of claim 18, wherein the method further comprises:
receiving, by the authenticator, a third set of factors, wherein the third set of factors comprise one of biometrics information or user credential information for the user, the user credential information comprising one or more of a username, a password, a PIN, and a passcode,
and wherein the second set of factors comprise at least one of the public key or the private key,
and wherein the second set of factors are unlocked based in part on receiving the third set of factors.

20. A system configured for digital authentication, the system comprising:
one or more hardware processors configured by machine-readable instructions to:
provide an authenticator for use with a first computing device;
display a login screen on the first computing device, wherein the login screen is associated with an application;
receive a first set of factors at the first computing device;
send information related to the first set of factors to a processing system;
receive a second set of factors from one of the first computing device or a second computing device; and
use information related to one or more of the first set of factors and the second set of factors to:
authenticate the application on the first computing device, and
authenticate a user on the login screen displayed on the first computing device, wherein authenticating the user comprises enabling one or more components of the application, the one or more components comprising at least one of (a) linking a user account associated with the user to the second set of factors, (b) completing a purchase on the application, or (c) automatically logging the user into the application,
or a combination thereof.
